(19) United States
(12) Patent Application Publication
(10) Pub. No.: US 2025/0310305 A1
(43) Pub. Date: Oct. 2, 2025

(54) Method and Apparatus for Flit Format Conversion

(71) Applicant: Arm Limited, Cambridge (GB)

(72) Inventors: Mark Gerald LaVine, Austin, TX (US); Ashok Kumar Tummala, Cedar Park, TX (US)

(73) Assignee: Arm Limited, Cambridge (GB)

(21) Appl. No.: 18/617,799

(22) Filed: Mar. 27, 2024

(51) Int. Cl. H04L 9/40; H04L 9/32

(52) U.S. Cl. CPC H04L 63/0428; H04L 9/3242

(57) ABSTRACT

An apparatus and method for converting flit formatting in a data process network. At a transmit stage of a flit converter, a packer is configured to pack in accordance with a packing logic of a first protocol one or more first flits having a first flit format into a flit container having a second flit format that is different from the first flit format of the one or more first flits and transmit the flit container having the one or more packed first flits across a link layer of a data processing network in accordance with a second protocol that differs from the first protocol. At a receive stage of the flit converter, an unpacker is configured to: receive in accordance with the second protocol the flit container packed with one or more packed first flits in a second flit format and unpack in accordance with an unpacking logic of a third protocol the one or more first flits from the flit container.

### BACKGROUND

A network flow control unit or network “flit” is an atomic block of data that is transported across a data processing network by hardware. A single transaction message may be transported in multiple network flits, consisting of a header flit, body flits and, optionally, a tail flit. Alternatively, one or more transaction messages can be packed in a single flit. In this case, packing of packets into flits is performed by hardware in the link layer of the network. A group of transaction messages are passed to a flit packing logic block that, in turn, packs the messages into one or more flits. When the passed transaction messages are too large to fit into a single flit, they overflow into one or more additional flits. As a result, the additional flits may be only partially filled, resulting in inefficient data transfer.

### BRIEF DESCRIPTION OF THE DRAWINGS

The accompanying drawings provide visual representations which will be used to describe various representative embodiments more fully and can be used by those skilled in the art to better understand the representative embodiments disclosed and their inherent advantages. In these drawings, like reference numerals identify corresponding or analogous elements.

FIG. 1 is a simplified block diagram of a data processing system, in accordance with embodiments.

FIG. 2 is a block diagram of a gateway block, in accordance with various representative embodiments.

FIG. 3 depicts a data processing network topology of traffic flow between chips, in accordance with various representative embodiments.

FIG. 4 illustrates an example 64 B flit format, in accordance with various representative embodiments.

FIG. 5 illustrates an example 256B flit format, in which FMT MAC is true, in accordance with various representative embodiments.

FIGS. 6A and 6B illustrate an example 256B flit format, in which FMT MAC is false, in accordance with various representative embodiments.

FIG. 7 illustrates an example 256B flit format, in which FMT MAC is false, in accordance with various representative embodiments.

FIG. 8 illustrates a transmit stage of a universal flit converter, in accordance with various representative embodiments.

FIG. 9 is a flow diagram that illustrates the overall flow for packing data flits in a flit container, in accordance with various representative embodiments.

FIG. 10 is a flow diagram that illustrates an initial chunk flow for packing data flits in a flit container, in accordance with various representative embodiments.

FIG. 11 is a flow diagram that illustrates subsequent chunk flow for packing data flits in a flit container, in accordance with various representative embodiments.

FIG. 12 illustrates a receive stage of a universal flit converter, in accordance with various representative embodiments.

FIG. 13 is a flow chart of a method of efficient transaction message unpacking, in accordance with various representative embodiments.

### DETAILED DESCRIPTION

The various apparatus and devices described herein provide mechanisms for packing transaction messages into a network flit in a data processing system.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

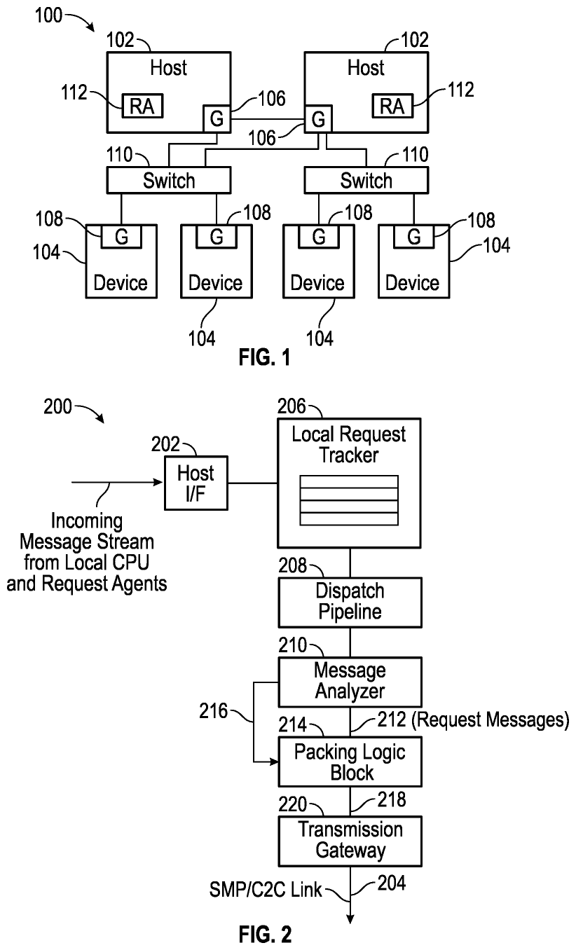

FIG. 1 is a simplified block diagram of a data processing network 100, in accordance with embodiments of the present disclosure. Data processing network 100 includes multiple integrated circuits (ICs) or chips, such as host ICs 102 and device ICs 104. A host IC may include a one or more processors. A chip-to-chip gateway 106 of a host IC 102 couples to corresponding chip-to-chip gateways 108 on device IC 104 to provide one or more communication links. The links in a link layer of the data processing network 100 enable messages to be passed, in one or more flits, between the host ICs and device ICs. The links may include switches 110 to enable a host IC to communicate with two or more device ICs or to enable two or more host ICs to communicate with the same device IC or with each other.

An example link is Compute Express Link™ (CXL™) of the Compute Express Link Consortium, Inc. CXL™ provides a coherent interface for ultra-high-speed transfers between a host and a device, including transaction and link layer protocols together with logical and analog physical layer specifications.

A further example link is a symmetric multi-processor or shared memory multiprocessing (SMP) link, as well as a coherent multi-chip link symmetric multi-processor (CML SMP), between processors with a shared memory.

Other example links and accompanying communication protocols include Cache Coherent Interconnect (CCIX), peripheral component express (PCIe), including PCIe Gen5 and PCIe Gen6, and universal chiplet interconnect express (UCIe).

Host 102 includes one or more requesting agents 112, such as a central processing unit (CPU) or CPU cluster.

Transactions between chips may involve an exchange of messages, such as requests and responses, including read, write and snoop requests. A packing logic block packs transaction messages and data into flow control units or “flits” to be sent over a symmetric multi-processor (SMP) or chip-to-chip (C2C) link. Herein, a packing logic block includes an integrated circuit block, or software description thereof, used in a modular data processing chip. In order to increase the bandwidth and link utilization, the packing logic block maximizes the number of request messages and data packed into each flit. The size of a request message size may vary. For example, a message may have a variable number of extension portions. The extension portions may be referred to herein as “extensions.” Thus, for the packing logic block to work most efficiently, it should be able to observe pending messages in order to determine the maximum number of messages and data that can fit into each network flit. However, this can increase the complexity, area and latency of the packing logic.

In accordance with various embodiments of disclosure, a universal flit converter apparatus and methodology for converting flit formatting in a data processing network is provided. Packing a flit container with flits having a different size than the flit container can be done at speed converts the flit format of the packed flits to the flit format of the flit container during transmission and receipt of the flit container. This approach allows operation at the line rate of a processor clock to be maintained while allowing multi-hop traffic to be routed directly to the link layer and also to interleave with other, non-multi-hop routed traffic. The universal converter apparatus and method described herein does not require changes to message credits, link credits or to packed flits and also support SMP port-to-port forwarding in addition to IDE link encryption without any modification to existing packing and unpacking logic. Further, the universal conversion is performed dynamically on incoming request streams from central processing unit (CPU) and peripheral component express (PCIe) request agents, and corresponding responses.

FIG. 2 is a block diagram of a gateway block 200 of a data processing network, in accordance with various representative embodiments. The gateway block receives request messages from various local request agents at host interface 202. These request messages are generated when a request agent needs to send a request, such as a read, write or snoop, to a destination that resides on a different chip. The request is sent to its destination via gateway block 200 and SMP/C2C link 204. Gateway block 200 is also configured to handle the responses from local agents.

A request from a local agent is allocated within local request tracker 206. Local request tracker 206 is a mechanism for monitoring transaction requests and may include a table for storing request identifiers and associated data such as transaction status. Requests that are ready to send are passed through request dispatch pipeline 208. Dispatch pipeline 208 may include a tracker request picker and a dispatch first-in, first-out (FIFO) buffer, for example. Message analyzer 210 observes the request messages and determines the number of messages to send. The selected messages 212 are sent to packing logic block 214. In addition, message analyzer 210 may provide signal 216, indicating the number of messages to be packed, to packing logic block 214. In turn, packing logic block 214 packs requests 212 into a transaction layer flit packet 218 (containing one or more network flits) and sends the packet to transmission gateway 220 to be transmitted over the SMP/C2C communication link 204 in the link layer of the data processing network. Response messages are treated in a similar manner. Message analyzer 210 is configured to analyze both request and response messages, collectively called “transaction messages” or just “messages.” Message analyzer 210 and packing logic block 214 may be implemented as a single logic block or as two or more logic blocks.

Packing logic block 214 can receive a limited number of messages in each clock cycle. For example, in one embodiment, a maximum of four messages per cycle can be sent to packing logic block 214. The packing logic block analyzes the size of each message and fits as many as possible into a first network flit. If the packing logic is not able to fit all the received messages into a single network flit, then additional network flits are used. However, an additional network flit may be only partially filled, leading to a decrease in packing efficiency, bandwidth and link utilization.

In accordance with various embodiments of the disclosure, a universal flit converter is an apparatus and methodology for converting flit formatting in a data processing network allows the maximum number of messages to be packed and transmitted/received in each cycle, optimizing packing efficiency, bandwidth and link utilization. A universal flit converter includes at a transmit stage a packer configured at a transmit stage of the flit converter to: pack in accordance with a packing logic of a first protocol one or more flits having a first flit format into a flit container having a second flit format that is different from the first flit format of the one or more flits; and transmit the flit container having the one or more packed flits across a link layer of a data processing network in accordance with a second protocol that differs from the first protocol. At a receive stage of the universal flit converter, an unpacker is configured at a receive stage of the flit converter to: receive in accordance with the second protocol the flit container packed with one or more packed flits in a second flit format; and unpack in accordance with an unpacking logic of a third protocol the one or more flits from the flit container. As used herein, a packer packs different and multiple messages, data, credits and other miscellaneous information into a flit container based on a supported format associated with the flits being packed, described as the first or third protocols herein. An unpacker unpacks different and multiple messages, data, credits and other miscellaneous information that has been packed into the flit container. Moreover, a flit container is a different sized flit, such as a larger sized flit, that has a unique format, referred to herein as a second flit format associated with a second protocol, and contains smaller flits packed into it that are supported by a different format associated with the first and/or third protocols than the flit container. Accordingly as used herein, a universal flit converter, sometimes referred to as a flit converter, refers to the ability to work with any flit format by virtue of converting from a first to a second flit format when packing a flit container and then back again when unpacking the flit container.

As provided herein, the first protocol, the second protocol and the third protocol may be coherent multi-chip link (CML), symmetric multi-processor (CML SMP), Cache Coherent Interconnect (CCIX), Compute Express Link (CXL), peripheral component express (PCIe), PCIe Gen5, PCIe Gen6, universal chiplet interconnect express (UCIe), Credited extensible Stream (CXS) streaming protocol and AMBA CHI Chip to Chip (C2C). The first protocol and the third protocol may be the same chip-to-chip protocol that is different from the second protocol, a chip-to-chip protocol. The second protocol of the flit container includes a link integrity and data encryption (IDE) of the link layer of the data processing network without requiring modification to the existing packing and unpacking logic of the first and third protocols.

The second flit format of the flit container is different than the first flit format of the one or more flits packed into it and may be larger. Thus, for example, the first flit format may be 64B flits and the second flit format is 256B flits, as will be described in several examples. However, these flit formats are not limited to these specific implementations. The third flit format may be the same as the first flit format or may be different.

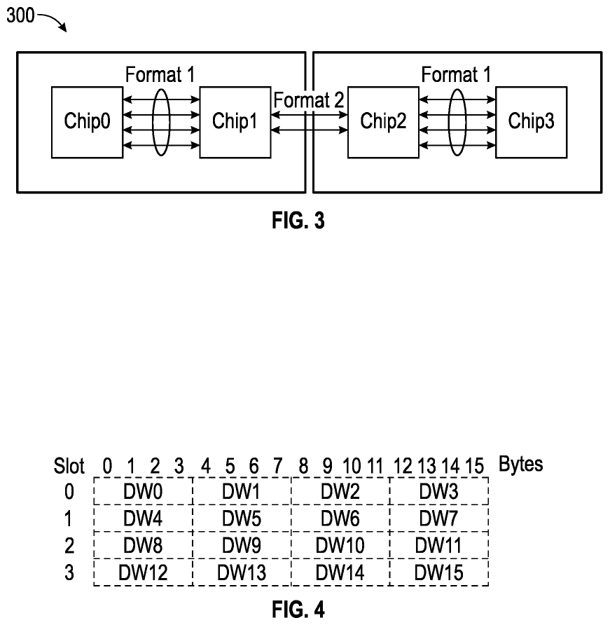

Referring now to FIG. 3, a data processing network topology 300 illustrates traffic flow between chips in which the universal flit converter is employed. Traffic between Chip0 and Chip1, and between Chip2 and Chip3, use Flit Format 1. Traffic between Chip1 and Chip 2 use Flit Format 2. In this topology, all of the chips are not fully connected. As shown, traffic between Chip0 and Chip2 hop across Chip1 using multi-hop routing; traffic between Chip0 and Chip3 hop across Chip1 and Chip2 using multi-hop routing; and traffic between Chip1 and Chip3 hop across Chip2 using multi-hop routing. While all the communication in this topology can use Flit Format 1 and the universal flit converter is used between Chip1 and Chip2 to convert Flit Format 1 to Flit Format 2. If Link IDE is enabled on links between Chip1 and Chip2, then, the packing logics across all chips, working on Flit Format 1, do not have to be aware of this Link IDE enablement. The converter block of the universal flit converter will be aware of the Link IDE enablement and will form the Flit Format 2 flits with IDE. While Flit Format 1 is used to for traffic between Chip0 and Chip1 as well as between Chip2 and Chip3, the Flit Format between either of these chip-to-chip communications could also be in another format, such as Flit Format 3 between Chip2 and Chip3 for example. The universal flit converter may be used to pack Flit Format 3 messages into a flit container using Format 2 to send traffic between Chip1 and Chip2 as shown.

For purposes of illustration, Flit Format 1 (and Flit Format 3) is discussed as 64B flit format while Flit Format 2 is discussed as 256B flit format, although it will be understood that other format sizes may be used without departing from the scope of the innovations described herein. In particular, it is envisioned that current links and link protocols will continue to evolve and the embodiments described herein would still be applicable.

Current CML_SMP and CCIX2.0 protocols, for example, use 64B flit/packet formats. These protocols define message packing rules to be packed in to 64B flits. For these protocols to use a PCIe Gen6 256B flit, therefore, would require a new set of packing rules to be defined. Instead, in accordance with various embodiments provided herein, a universal 256B flit converter packs the 64B flits/packets in a first flit format in to 256B flit container of a second flit format using a second stage packer and unpacks the incoming 256B flits using a first stage unpacker, so that the protocol logic sees the standard 64B flits of the first flit format. This conversion happens at the line rate, such as at a line rate of 2 GHz clock. Using 256B flits, link IDE cannot be seamlessly supported for topologies that include multi-hop routing. Without link IDE, multi-hop traffic would be required to go through the 64B packing logic to maintain the message authentication code (MAC) Epoch. The 256B universal flit converter logic allows MAC Epochs to be maintained while allowing multi-hop traffic to be routed directly to the link layer and also interleave with the other traffic (non-multi hop routed). In summary, this universal flit converter does not require changes to message credits, link credits, or PCIe Gen5 packed 64B flits and also supports SMP port-to-port forwarding in addition to IDE link encryption without any modification to the existing 64B packing and unpacking logic. In summary, a 256B universal flit converter can take any chip-to-chip protocol packets or flits and pack them into a 256B flit container which can be sent (transmitted) through PCIe Gen6 PHY link layer.

PCIe, CXL 2 and CCIX SMP 64B flit formats, for example, have all 64 bytes available for packed messages for the four 16 byte slots as shown in FIG. 4. 64B flit format with four 32 bit positions, also referred to a double word (DW), in each 16 byte slot. There are a total of 16 DWs in a 65B flit, as shown.

As an example, a 256 byte CXL/PCIe standard flit format reserves 16 bytes for the lower link layer transport as highlighted below in yellow and green. The universal flit converter packs and unpacks at 4 byte granularity of 4 byte aligned data, packing 64 bytes in the flit container per cycle, achieving 2 GHz operation in technologies such as 5 nm and smaller. Byte 2 highlighted in blue is used as an IDE indicator that has a MAC immediately following the IDE indicator. The remaining 2 bytes highlighted in tan are available for future expansion. Packing 4 bytes from each 64B flit in the flit container allows for utilization of 236 bytes in a 256B flit, which allows packing three 64B flits and 44 bytes from a 4th 64B flit. The 20 byte remainder is packed at the beginning of the next 256B flit. Packing 236B/256B in the flit container achieves a 92.1875% packing efficiency, but will be transmitted using PCIe Gen6 that has double the frequency of PCIe Gen5, thereby generating a bandwidth uplift of 184%.

The 256B standard flit format has four 32 bit positions in each slot. The non-highlighted positions are densely packed from multiple 64B flits allowing for rollover between 64B chunks (every 4 slots) and 256B flits. In this example, there are a total of 59 DWs in a 256B flit that is packed/unpacked in 4 cycles with:
Chunk0 contains slot 0 thru slot 3
Chunk1 contains slot 4 thru slot 7
Chunk2 contains slot 8 thru slot 11
Chunk3 contains slot 12 thru slot 15

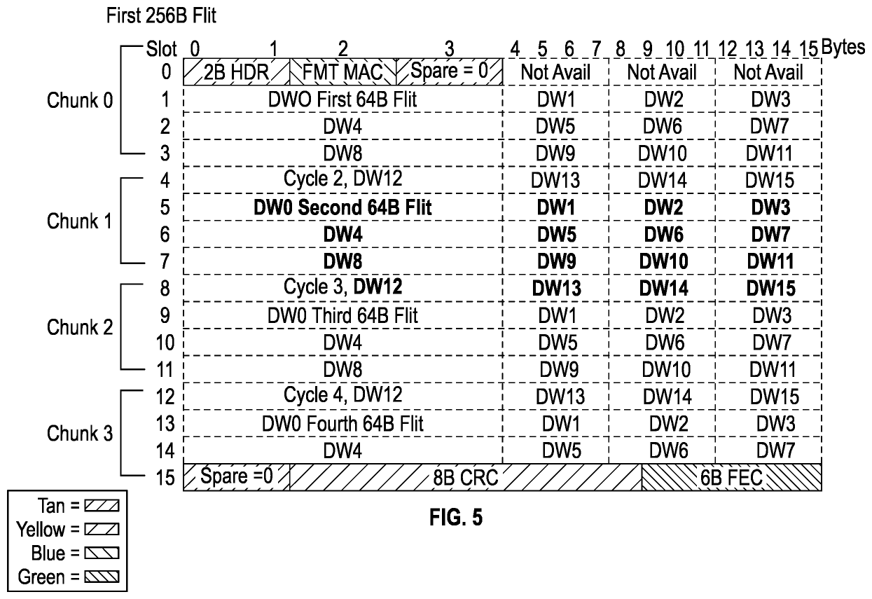

Note the yellow and green areas are needed for the CXL PHY physical link layer and cannot be used for packing flits. Format message authentication code (FMT MAC) being true means that space must be reserved for the MAC encryption, so slot0 cannot be used to hold 64B flit data. Referring to FIG. 5, an example in which FMT MAC is true is shown.

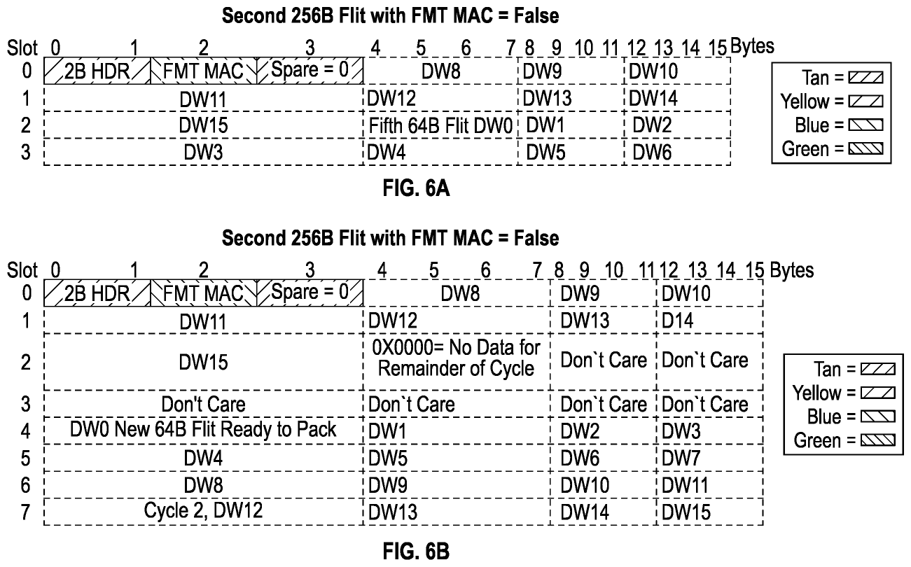

Consider next two examples of a second 256B flit with FMT MAC is false. In the second 256B flit of FIG. 6A, FMT MAC=False and the remainder of the DWs from the fourth 64B flit and the fifth 64B flit are shown. In the alternative second 256B flit of FIG. 6B, FMT MAC=False and the remainder of the DWs from the fourth 64B flit are shown. However, there is no additional 64B flit to pack, so the zero value at the end of the fourth 64B flit means there is no more data in this chunk.

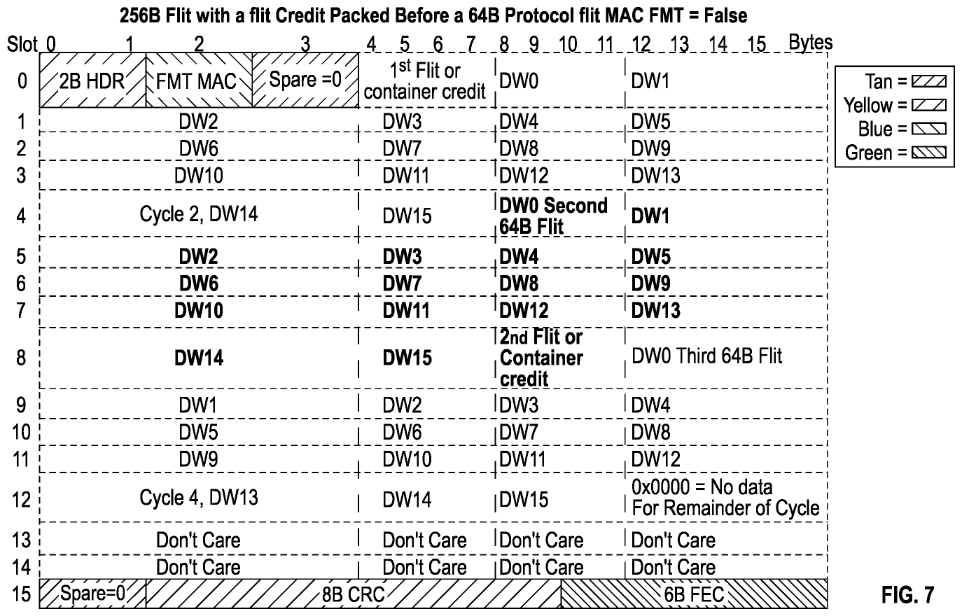

Referring now to FIG. 7, another example is shown of a 256B flit container packed with a flit link credit before a 64B protocol flit is packed, in which MAC FMT=false.

For CCIX/SMP and CXL protocols, headers are not always zero values for the first 32 bits, so the universal flit converter can use a 32 bit zero header to indicate that the remainder of the current 64B chunk of the 256B flit is zero. Messages and data from a 64B flit could then be packed in the next cycle of the 256B flit. Messages and data can rollover 64B chunks and also rollover 256B flits.

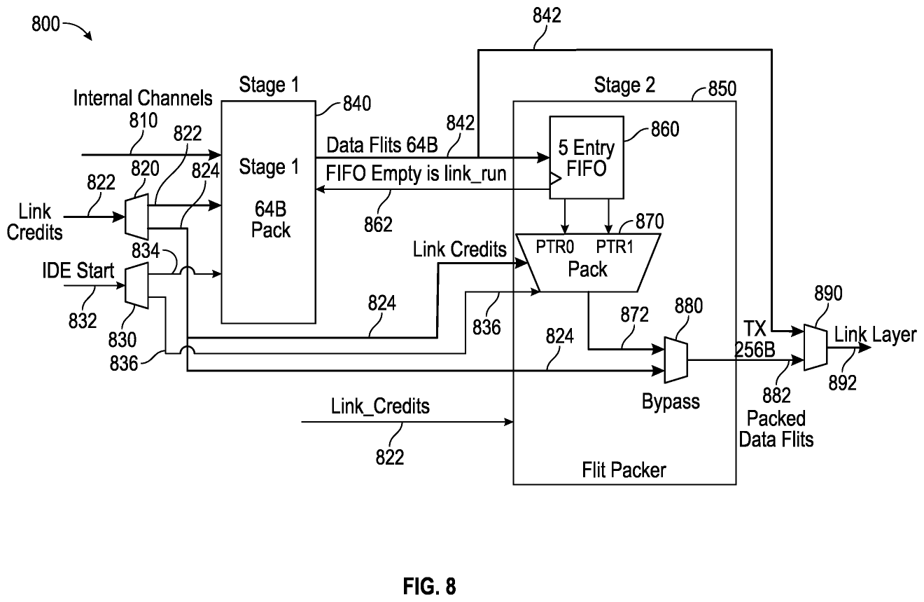

It is noted that SMP protocol requires a link credit for each flit 64B protocol or data flit that is transmitted. It also uses a standalone 64B link credit flit (that does not need a link credit) to send link credits when credits cannot be sent with the protocol flit (may need message credits, or multiple link credits). The universal flit converter in this case will pack link credits in any 32 bit position, in between 64B protocol data flits, or a zero header with bit 0 set to indicate that it is not a protocol flit (bit 0 is used by SMP as a flit type indicator). An all data flit counter based on the CCIX header length is used to determine a data flit versus a protocol header. The 256B packing logic of the flit container protocol also includes logic to insert IDE encryption MACs in addition to the link credits as shown in the diagram of FIG. 8.

Referring now FIG. 8, a transmit stage 800 of a universal flit converter is illustrated. In the example shown, a universal 256B flit converter packs the 64B flits/packets in a first flit format in to 256B flit container of a second flit format using a second stage packer. Internal channels 810, including channels for requests, response, data and credit traffic, is provided to the Stage 1 64B packer 840. Link credits 822 are gated at logic 820 and provided to packer 840, packer packing logic 870 of flit packer 850 and bypass gate logic 880 of flit packer 850. Link credits 822 come from a credit manager on the lower link layer (LLL) transport in the first flit format of the received data flits 842. An optional IDE state signal 832 is provided to gating logic 830 that provides link IDE signal 834 to stage 1 packer 840 and link IDE signal 836 to packing logic 870 of Stage 2 flit packer 850. 64B flits 842 are provided to first in first out (FIFO) 860 of flit packer 850, which in turns provide signal 862 that notifiers stage 1 packer 840 when FIFO 860 is empty. Packer packing logic 870 uses two pointers PRT0 and PTR1 that receive inputs from FIFO 860, as well as link credits 824 from logic 820 and Link IDE control signal 836 from IDE gating logic 830. Link credits 824 may be 4 bit link credits, as previously described. The output 872 of packing logic 870 and link credits 824 are provided to bypass logic 880, the output of which is packed 256 flit container 882, which are passed to logic 890 before being transmitted 892 to the link layer of the data network at 890. Bypass logic 880 is controlled by either 820 or packing logic 870 to allow for a bypass if needed. Moreover, the 64B data flits 842 and the 256B packed data flits 882 may be in a variety of formats and protocols, including the CXS streaming protocol.

Notably, packer packing logic 870 using packing logic of a first protocol consistent with the flit format of the 64B flits that it is packing into the flit container, that is different from the flit format and second protocol of the 256B flit container that is being packed. Transmission of the 256B flit container packed with one or more 64B flits is conducted in accordance with the second protocol of the 256B flit container. The link IDE 836 is defined for the second protocol of the 256B flit container.

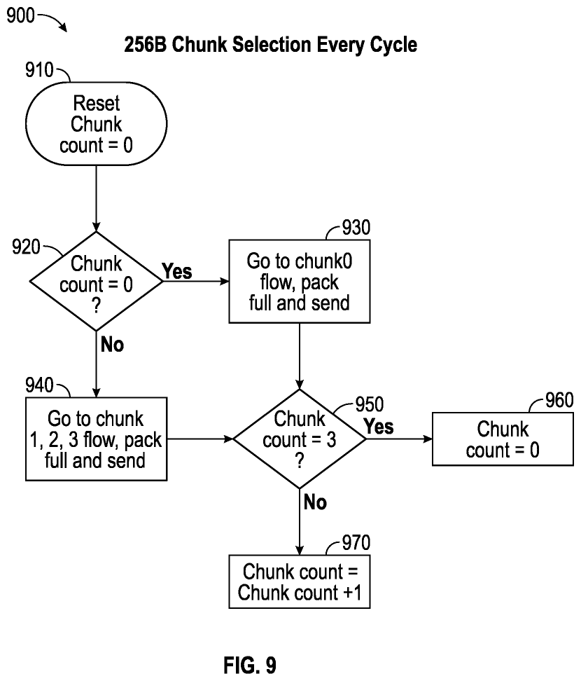

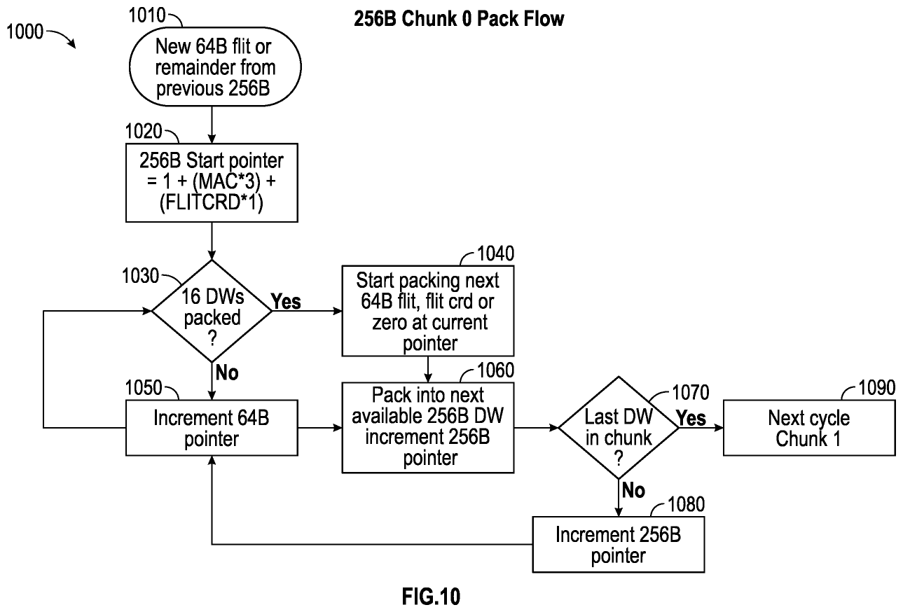

Referring to FIG. 9, a flow 900 illustrates the overall flow for packing data flits in a 256B flit container, described as packing n chunks over n sequential cycles of a processor. At 910, the chunk count is reset to zero (0). At decision block 920 if the chunk count is 0, at 930 the flow continues to the Chunk 0 flow illustrated in FIG. 10. If, at decision block 950, the chunk count equals 3, then the chunk count is reset to 0. If no, the flow continues from decision block 950 where the chunk count is incremented. If, at decision block 920, however, the chunk count is not zero, then the flow continues to the Chunk 1, 2, 3 flow of FIG. 10.

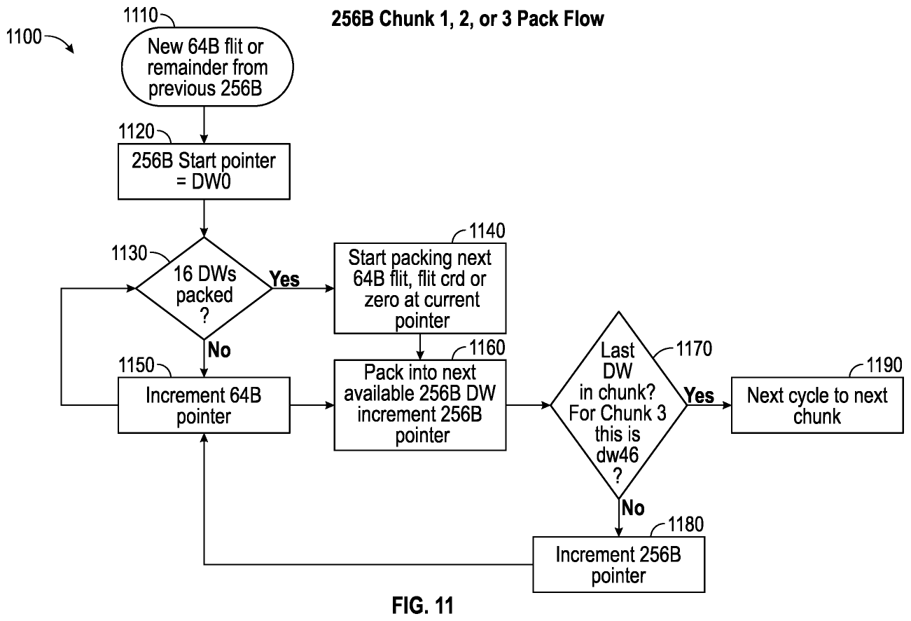

The 256B Chunk 0 pack flow 1000 is illustrated in FIG. 10. At 1010, the flow begins with a new 64B flit or the remainder from a previous 256B flit. At 1020, the 256B start pointer is defined s 1+ (MAC*3)+ (FLITCRD*1). If, at decision block 1030, 16 DWs are packed, the flow continues to 1040 where start packing the next 64B flit, flit credit or zero at the current pointer value. At 1060, this is packed into the next available 256B DW and the 256B pointer is incremented. If at decision block 1030, there are not 16 DWs packed, the 64K pointer is incremented and the flow continues to 1060. After 1060, the flow continues to 1070. If the last DW in the chunk, the flow continues to Chunk 1 at the next cycle. The flow for Chunks 1, 2, 3 is shown in FIG. 11. If at 1070, it is not the last DW in the chunk, the 256B pointer is incremented and flow returns to 1050.

In FIG. 11, the flow 1100 for Chunks 1, 2, 3 in this example is shown. At 1110 the flow begins with a new 64B flit or the remainder from a previous 256B flit. Packing of the 256 flit container starts with the pointer=DW0. At 1130, the query is whether 16 DWs have been packed. If yes, then at 1140, start packing the next 64B flit, flit credit or zero (0) at the current pointer. At bock 1160, the 64B flit is packed into the next available 256B DW and the 256B pointer is incremented. If no, then from 1130 the flow goes to 1150 where the 64B pointer is incremented. Going now to 1170, the query regards the last DW in the chunk. If it is the last DW in the chunk, the 256B pointer is incremented at 1180 and the 64B pointer is incremented at 1150. For the third chunk, Chunk 3, this is DW 46 in this example. At 1190, the flow continues in the next cycle to the subsequent chunk.

In the above packing flows 1000 and 1100 of the universal flit converter on the transmit side, it will be appreciated that two pointers PT0 and PT1 are used, corresponding to the two 64B pointers used for FIFO stored source data and the 256B destination pointer discussed in the flows. The 256B chunk pointer contains both a start and an end pointer based on last DW in chunk, only the start pointer is incremented.

In view of the above, in accordance with various embodiments of disclosure, a universal flit converter methodology for converting flit formatting in a data processing network is provided. A method of converting flit formatting in a data processing network includes: converting in accordance with a packing logic of a first protocol one or more flits having a first flit format into a flit container having a second flit format different from the first flit format; and transmitting at a first chip, for example, the flit container having the second flit format across a link layer of the data processing network in accordance with a second protocol. Converting includes packing in accordance with a packing logic of the first protocol the one or more flits into the flit container having the second flit format.

Packing one or more message credits and link credits in the first flit format of the one or more flits is described. Link credits and one or more integrity and data encryption (IDE) message authentication codes (MACs) can be packed in the first flit format of the one or more flits, the one or more IDE MACs including a link IDE that is defined for the second protocol. Multiples of the one or more flits can be packed into the flit container in which n chunks over n sequential cycles of a processor are packed.

As set forth below, the flit container transmitted by example a first chip across a link layer of a data processing network can be received and the flits packed therein recovered at a second chip at a receive stage of a universal flit converter. Accordingly, the flit container is received in accordance with the second protocol of the flit container and recovery of the packed flits is conducted according to a third protocol. Recovering the one or more flits in the first flit format includes unpacking in accordance with an unpacking logic of the third protocol the one or more flits from the flit container. The unpacking logic used in accordance with the third protocol may in fact be the same as the first protocol with which they were packed or they may be different. Multiples of the one or more flits can be recovered from the flit container in which n chunks over n sequential cycles of a processor are unpacked.

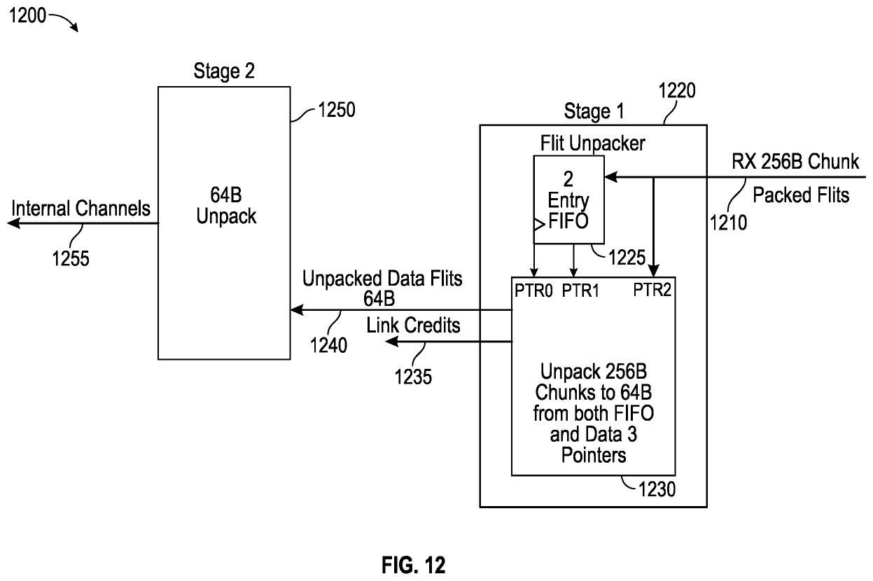

Referring now to FIG. 12, a receive stage 1200 of a universal flit converter that unpacks incoming 256B flits using a first stage unpacker is illustrated. 256B packed flits in the flit container 1210 are received by Stage 1 of flit unpacker 1220 in accordance with the second protocol of the 256B flit container. Flit unpacker 1220 has FIFO logic 1225 and unpacking logic of unpacker 1230 that uses three pointers PTR0, PTR1, PRT2. Unpacking logic of unpacker 1230 unpacks the incoming 256 flit container in which one or more 256B flit chunks are packed in accordance with the first protocol used by the 64B flits. Unpacking logic of unpacker 1230 unpacks 256B chunks into 64B flits in accordance with operation of the FIFO logic 1225 and the received 256 chunk packed flits 1210 using three pointers PTR0, PTR1, PRT2.

The unpacked 64B data flits 1240 are provided to a Stage 1 64B unpacker 1250 and the link credits 1235 are sent on the LLL transport to the credit manager. The unpacked 64B flits, as well as credit, request and response data is sent along internal channels 1255.

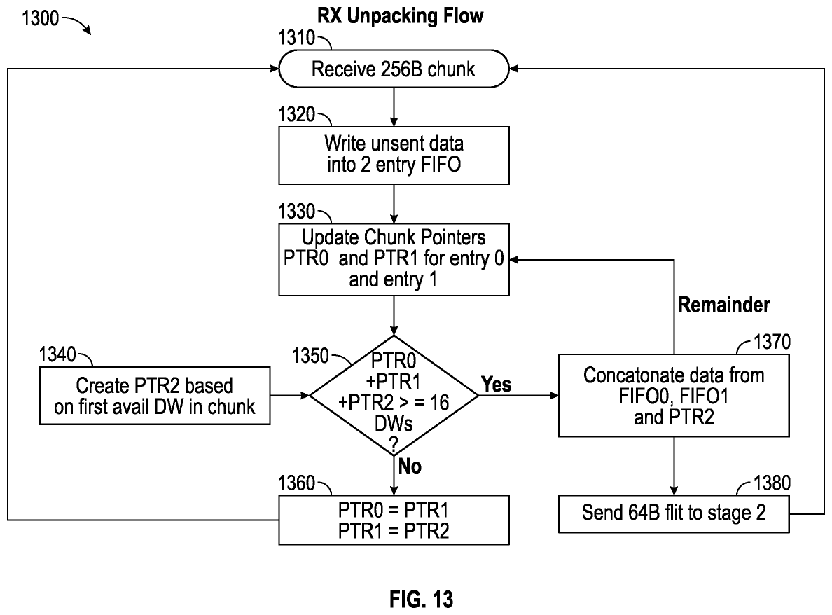

In FIG. 13, a flow 1300 illustrates unpacking of flits that are packed in a flit container. Continuing with the 64B/256B example, at 1310, a 256B chunk is received. Any unsent data is written into a two entry FIFO, in this particular example. At 1330, the chunk pointers PTR0 and PTR1 for Entry 0 and Entry 1 are updated; reference is made to FIFO 1225 of FIG. 12. The query at decision block 1350 is whether the sum of PTR0, PTR1 and PTR2 is greater than or equal to 16 DWs, shown by this expression:

PTR0+PTR1+PTR2>=16 DWs

If no, at 1360, PTR0 is registered or stored to PTR1 and PTR1 is registered or stored to PTR2, and the flow returns to 1310 as shown. If yes, at 1370, data from FIFO0, FIFO1 and PTR2 are concatenated. The remainder is provided to 1330 and the flow continues to 1380 in which the 64B flit is sent to the Stage 2 unpacker 1250 of FIG. 12.

PTR2 points to the CXS data that was received in the current clock cycle. PTR1 refers to the FIFO stored CXS data that was received in the prior cycle, and PTR0 refers to the FIFO stored CXS data that was received two cycles ago. The unpacked data will be constructed using data from one, two or all three pointers depending on the chunk, and remainder from previous 64B data. In this case it can be seen that each pointer also refers to both a start and end pointer. Only the start pointer is incremented, the end pointer is selected based on the last DW in the chunk.

As described, the packer of the flit converter packs and the unpacker of the flit converter unpacks at a common granularity of aligned data per cycle. The universal converter is configured to pack n chunks over n sequential cycles and unpack n chunks over n sequential cycles, where each chunk of the n chunks has an equal number of slots. The packer is configured to pack multiples of the one or more flits into the flit container and the unpacker is configured to unpack multiples of the one or more flits from the flit container. In the examples described, the universal flit converter packs and unpacks at, for example, 4 byte granularity of 4 byte aligned data, packing 64 bytes in the flit container per cycle, achieving 2 GHz operation in technologies such as 5 nm and smaller.

The embodiments described herein are combinable.

In one embodiment, an apparatus for converting flit formatting in a data processing network includes a packer configured at a transmit stage of the flit converter to: pack in accordance with a packing logic of a first protocol one or more first flits having a first flit format into a flit container having a second flit format that is different from the first flit format of the one or more first flits; and transmit the flit container having the one or more packed first flits across a link layer of a data processing network in accordance with a second protocol that differs from the first protocol.

In another embodiment, the packer is further configured to pack one or more message credits and link credits in the first flit format of the one or more first flits.

In another embodiment, the packer is configured to pack one or more link credits and one or more integrity and data encryption (IDE) message authentication codes (MACs), the one or more IDE MACs including a link IDE that is defined for the second protocol.

In another embodiment, the second flit format of the flit container is larger than the first flit format of the one or more flits.

In another embodiment, an unpacker configured at a receive stage of the flit converter to receive in accordance with the second protocol the flit container packed with one or more packed first flits in a second flit format; and unpack in accordance with an unpacking logic of a third protocol the one or more first flits from the flit container.

In another embodiment, the packer of the flit converter packs and the unpacker of the flit converter unpacks at a common granularity of aligned data per cycle.

In another embodiment, the flit converter is configured to pack n chunks over n sequential cycles and unpack n chunks over n sequential cycles, where each chunk of the n chunks has an equal number of slots.

In another embodiment, the packer is configured to pack multiples of the one or more first flits into the flit container and the unpacker is configured to unpack multiples of the one or more first flits from the flit container.

In another embodiment, a non-transitory computer-readable medium storing computer-readable code for fabrication of the apparatus of claim 1.

In one embodiment, a method of converting flit formatting in a data processing network includes: converting in accordance with a packing logic of a first protocol one or more flits having a first flit format into a flit container, the flit container having a second flit format different from the first flit format; and transmitting the flit container having the second flit format across a link layer of the data processing network in accordance with a second protocol.

In another embodiment, the converting includes packing in accordance with a packing logic of the first protocol the one or more flits into the flit container having the second flit format.

In another embodiment, packing one or more message credits and link credits in the first flit format of the one or more flits.

In another embodiment, packing one or more link credits and one or more integrity and data encryption (IDE) message authentication codes (MACs) in the first flit format of the one or more flits, the one or more IDE MACs including a link IDE that is defined for the second protocol.

In another embodiment, packing multiples of the one or more flits into the flit container.

In another embodiment, packing n chunks over n sequential cycles of a processor.

In another embodiment, receiving at a second chip the flit container and recovering in accordance with a third protocol the one or more flits in the flit container.

In another embodiment, recovering the one or more flits in the first flit format includes unpacking in accordance with an unpacking logic of the third protocol the one or more flits from the flit container.

In another embodiment, the converting and recovering including packing n chunks over n sequential cycles and unpacking n chunks over n sequential cycles, where each chunk of the n chunks has an equal number of slots.

In one embodiment, a method of converting flit formatting in a data processing network includes: converting in accordance with a packing logic of a first protocol one or more flits having a first flit format into a flit container having a second flit format different from the first flit format; transmitting at a first chip of the data processing network the flit container having the one or more flits across a link layer of the data processing network in accordance with a second protocol; and receiving at a second chip the flit container transmitted over the link layer and recovering in accordance with a third protocol the one or more flits in the flit container.

In another embodiment, packing one or more link credits and one or more integrity and data encryption (IDE) message authentication codes (MACs) in the first flit format of the one or more flits, the one or more IDE MACs including a link IDE that is defined for the second protocol.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

What is claimed is:

1. An apparatus for converting flit formatting in a data processing network, comprising:
a packer configured at a transmit stage of the flit converter to:
pack in accordance with a packing logic of a first protocol one or more first flits having a first flit format into a flit container having a second flit format that is different from the first flit format of the one or more first flits; and
transmit the flit container having the one or more packed first flits across a link layer of a data processing network in accordance with a second protocol that differs from the first protocol.

2. The apparatus of claim 1, wherein the packer is further configured to pack one or more message credits and link credits in the first flit format of the one or more first flits.

3. The apparatus of claim 2, wherein the packer is configured to pack one or more link credits and one or more integrity and data encryption (IDE) message authentication codes (MACs), the one or more IDE MACs including a link IDE that is defined for the second protocol.

4. The apparatus of claim 1, wherein the second flit format of the flit container is larger than the first flit format of the one or more flits.

5. The apparatus of claim 1, the flit converter further comprising:
an unpacker configured at a receive stage of the flit converter to:
receive in accordance with the second protocol the flit container packed with one or more packed first flits in a second flit format; and
unpack in accordance with an unpacking logic of a third protocol the one or more first flits from the flit container.

6. The apparatus of claim 5, wherein the packer of the flit converter packs and the unpacker of the flit converter unpacks at a common granularity of aligned data per cycle.

7. The apparatus of claim 6, wherein the flit converter is configured to pack n chunks over n sequential cycles and unpack n chunks over n sequential cycles, where each chunk of the n chunks has an equal number of slots.

8. The apparatus of claim 5, wherein the packer is configured to pack multiples of the one or more first flits into the flit container and the unpacker is configured to unpack multiples of the one or more first flits from the flit container.

9. A non-transitory computer-readable medium storing computer-readable code for fabrication of the apparatus of claim 1.

10. A method of converting flit formatting in a data processing network, comprising:
converting in accordance with a packing logic of a first protocol one or more flits having a first flit format into a flit container, the flit container having a second flit format different from the first flit format; and
transmitting the flit container having the second flit format across a link layer of the data processing network in accordance with a second protocol.

11. The method of claim 10, wherein the converting includes packing in accordance with a packing logic of the first protocol the one or more flits into the flit container having the second flit format.

12. The method of claim 10, further comprising packing one or more message credits and link credits in the first flit format of the one or more flits.

13. The method of claim 12, further comprising packing one or more link credits and one or more integrity and data encryption (IDE) message authentication codes (MACs) in the first flit format of the one or more flits, the one or more IDE MACs including a link IDE that is defined for the second protocol.

14. The method of claim 10, further comprising packing multiples of the one or more flits into the flit container.

15. The method of claim 14, further comprising packing n chunks over n sequential cycles of a processor.

16. The method of claim 10, further comprising:
receiving at a second chip the flit container and recovering in accordance with a third protocol the one or more flits in the flit container.

17. The method of claim 16, wherein recovering the one or more flits in the first flit format includes unpacking in accordance with an unpacking logic of the third protocol the one or more flits from the flit container.

18. The method of claim 17, the converting and recovering including packing n chunks over n sequential cycles and unpacking n chunks over n sequential cycles, where each chunk of the n chunks has an equal number of slots.

19. A method of converting flit formatting in a data processing network, comprising:
converting in accordance with a packing logic of a first protocol one or more flits having a first flit format into a flit container having a second flit format different from the first flit format;
transmitting at a first chip of the data processing network the flit container having the one or more flits across a link layer of the data processing network in accordance with a second protocol; and
receiving at a second chip the flit container transmitted over the link layer and recovering in accordance with a third protocol the one or more flits in the flit container.

20. The method of claim 19, further comprising packing one or more link credits and one or more integrity and data encryption (IDE) message authentication codes (MACs) in the first flit format of the one or more flits, the one or more IDE MACs including a link IDE that is defined for the second protocol.
